(19) United States
(12) Patent Application Publication
(10) Pub. No.: US 2025/0178540 A1
(43) Pub. Date: Jun. 5, 2025

(54) VEHICLE HITCH MOUNTED CARGO BASKET

(71) Applicant: Pakmule, LLC, New Braunfels, TX (US)

(72) Inventor: Kansas SARTIN, New Braunfels, TX (US)

(73) Assignee: Pakmule, LLC, New Braunfels, TX (US)

(21) Appl. No.: 19/051,665

(22) Filed: Feb. 12, 2025

Related U.S. Application Data
(63) Continuation-in-part of application No. 17/300,322, filed on Nov. 10, 2022.

(51) Int. Cl. B60R 9/06

(52) U.S. Cl. CPC B60R 9/06

(57) ABSTRACT

A vehicle hitch mounted cargo basket includes a floor, at least one lip member, a rim, a connector, at least one reinforcing member, and a plurality of L brackets. The at least one lip member extending upwardly from a top surface of the floor. The rim attached to a top edge of each lip member. The connector removably connected to at bottom surface of the floor at or near a midpoint between the floor first end and the floor second end. The connector including a connector first section, a connector second section, and a riser section configured to allow a vertical distance between the connector first section and the connector second section. The at least one reinforcing member attached to the bottom surface of the floor. The plurality of L brackets configured to removably connect between at least one of the lip members and the connector. At least a portion of the connector extending past a floor second edge and being configured to mate with a vehicle hitch receiver.

### CROSS REFERENCES AND PRIORITIES

This Application claims priority to U.S. application Ser. No. 17/300,322 filed on 10 Nov. 2022, the teachings of which are incorporated by reference herein in their entirety.

### BACKGROUND

Many vehicles, in particular trucks, vans, and sport-utility vehicles (SUVs) come equipped with a hitch receiver. The hitch receiver is traditionally used to mount a tow ball to which a trailer may be connected.

In recent years, hitch receivers have been used to connect other mechanisms—such as bike racks and cargo storage baskets—to a vehicle. Cargo storage baskets in particular allow a vehicle operator to transport a small amount of cargo using their vehicle without the hassle, weight, and load balancing issues that come with towing a traditional trailer.

Existing cargo storage baskets are often heavy—making them difficult to install by a single operator. In addition, existing cargo storage baskets have limited options for attaching straps and other safety mechanisms used to hold cargo in place within the basket. They are also generally small, do not add sufficient additional cargo space, and—when loaded—prevent access to the rear cargo area of the vehicle. Additionally, they are often prone to wobbling.

The need exists, therefore, for an improved vehicle hitch mounted cargo basket which is lightweight, allows for sufficient options for attaching straps and other safety mechanisms used to hold cargo in place within the basket during operation, provide additional capacity and cargo access, and reduce or eliminate wobble.

### SUMMARY

Described herein is a vehicle hitch mounted cargo basket kit including a floor, at least one lip member, a rim, a plurality of connectors, at least one reinforcing member, and a plurality of L brackets with at least a portion of each connector of the plurality of connectors configured to extend past a floor second edge. The floor including a floor first side, a floor second side opposite the floor first side, a floor first end extending between the floor first side and the floor second side, and a floor second end opposite the floor first end. The floor also including a top surface and a bottom surface. The at least one lip member extending upwardly from the top surface. The rim attached to a top edge of each lip member. The plurality of connectors configured to interchangeably attach to the bottom surface at or near a midpoint between the floor first end and the floor second end. The at least one reinforcing member attached to the bottom surface of the floor. The plurality of L brackets configured to attach between at least one of the lip members and the connector.

In some embodiments, the plurality of connectors may comprise at least a first connector and at least one second connector. The first connector including a first connector member having a first connector first end, a first connector second end opposite the first connector first end, and the first connector longitudinal section extending between the first connector first end and the first connector second end. The at least one second connector including a connector first section, a connector second section, and a riser section. The connector first section having a connector first section first end, a connector first section second end opposite the connector first section first end, and a connector first section longitudinal section extending between the connector first section first end and the connector first section second end. The connector second section having a connector second section first end, a connector second section second end opposite the connector second section first end, and a connector second section longitudinal section extending between the connector second section first end and the connector second section second end. The riser section connected to and extending substantially vertically between the connector first section second end and the connector second section first end.

In certain embodiments, the at least one second connector may comprise a first second connector and a second second connector. The first second connector having a first riser section configured to allow a vertical distance between the connector first section and the connector second section in a range of between 3 inches and 5 inches. The second second connector having a second riser section configured to allow a vertical distance between the connector first section and the connector second section in a range of between 5 inches and 9 inches.

In some embodiments, one or more holes may pass through the floor from the top surface through the bottom surface.

In certain embodiments, the at least one lip member may include a first lip member, a second lip member, a third lip member, and a fourth lip member. The first lip member extending upwardly from the top surface along at least a portion of the floor first side. The second lip member extending upwardly from the top surface along at least a portion of the floor second side. The third lip member extending upwardly from the top surface along at least a portion of the floor third side. The fourth lip member extending upwardly from the top surface along at least a portion of the floor fourth side.

In some embodiments, the at least one lip member may include at least one slot. In certain embodiments, the rim may have a substantially cylindrical cross sectional profile. In some embodiments, the rim may have a shape and size which substantially conforms to the exterior profile of the floor.

In certain embodiments, the at least one reinforcing member comprises two reinforcing members connected to the bottom surface and extending between the floor first side and the floor second side.

In some embodiments, the vehicle hitch mounted cargo basket may be comprised of a material which comprises aluminum.

Also disclosed herein is a vehicle hitch mounted cargo basket which includes a floor, at least one lip member, a rim, a connector, at least one reinforcing member, and a plurality of L brackets with at least a portion of the connector extending past a floor second edge and configured to mate with a vehicle hitch receiver. The floor including a floor first side, a floor second side opposite the floor first side, a floor first end extending between the floor first side and the floor second side, and a floor second end opposite the floor first end. The floor also including a top surface and a bottom surface. The at least one lip member extending upwardly from the top surface. The rim attached to a top edge of each lip member. The removably connected to the bottom surface at or near a midpoint between the floor first end and the floor second end and including a connector first section, a connector second section, and a riser section. The connector first section having a connector first section first end, a connector first section second end opposite the connector first section first end, and a connector first section longitudinal section extending between the connector first section first end and the connector first section second end. The connector second section having a connector second section first end, a connector second section second end opposite the connector second section first end, and a connector second section longitudinal section extending between the connector second section first end and the connector second section second end. The riser section connected to and extending substantially vertically between the connector first section second end and the connector second section first end. The at least one reinforcing member attached to the bottom surface of the floor. The plurality of L brackets configured to attach between at least one of the lip members and the connector.

In some embodiments, the riser section may be configured to allow a vertical distance between the connector first section and the connector second section in a range of between 3 inches and 5 inches. In other embodiments, the riser section may be configured to allow a vertical distance between the connector first section and the connector second section in a range of between 5 inches and 9 inches.

In some embodiments, one or more holes may pass through the floor from the top surface through the bottom surface.

In certain embodiments, the at least one lip member may include a first lip member, a second lip member, a third lip member, and a fourth lip member. The first lip member extending upwardly from the top surface along at least a portion of the floor first side. The second lip member extending upwardly from the top surface along at least a portion of the floor second side. The third lip member extending upwardly from the top surface along at least a portion of the floor third side. The fourth lip member extending upwardly from the top surface along at least a portion of the floor fourth side.

In some embodiments, the at least one lip member may include at least one slot. In certain embodiments, the rim may have a substantially cylindrical cross sectional profile. In some embodiments, the rim may have a shape and size which substantially conforms to the exterior profile of the floor.

In certain embodiments, the at least one reinforcing member comprises two reinforcing members connected to the bottom surface and extending between the floor first side and the floor second side.

In some embodiments, the vehicle hitch mounted cargo basket may be comprised of a material which comprises aluminum.

### BRIEF DESCRIPTION OF FIGURES

FIG. 1 shows a perspective view of an embodiment of a vehicle hitch mounted cargo basket.

FIG. 2 shows a top view of the vehicle hitch mounted cargo basket of FIG. 1.

FIG. 3 shows a bottom view of the vehicle hitch mounted cargo basket of FIG. 1.

FIG. 4 shows a front view of the vehicle hitch mounted cargo basket of FIG. 1.

FIG. 5 shows a rear view of the vehicle hitch mounted cargo basket of FIG. 1.

FIG. 6 shows a right-side view of the vehicle hitch mounted cargo basket of FIG. 1.

FIG. 7 shows a left-side view of the vehicle hitch mounted cargo basket of FIG. 1.

FIG. 8 shows an exploded perspective view of an embodiment of a vehicle hitch mounted cargo basket with a riser.

FIG. 9 shows an assembled perspective view of the embodiment of a vehicle hitch mounted cargo basket with riser of FIG. 8.

FIG. 10 shows an exploded left-side view of an embodiment of a vehicle hitch mounted cargo basket with a riser.

FIG. 11 shows an assembled left-side view of the embodiment of a vehicle hitch mounted cargo basket with riser of FIG. 10.

### DETAILED DESCRIPTION

Disclosed herein is a vehicle hitch mounted cargo basket. The vehicle hitch mounted cargo basket is described below with reference to the Figures. As described herein and in the claims, the following numbers refer to the following structures as noted in the Figures.
10 refers to a vehicle hitch mounted cargo basket.
100 refers to a floor.
110 refers to a floor first side.
120 refers to a floor second side.
130 refers to a floor first end.
140 refers to a floor second end.
150 refers to a top surface.
160 refers to a bottom surface.
170 refers to holes.
200 refers to lip members
210 refers to a first lip member
220 refers to a second lip member.
230 refers to a third lip member.
240 refers to a fourth lip member.
250 refers to slots.
300 refers to a rim.
400 refers to a connector.
410 refers to a first connector.
411 refers to a first connector member.
412 refers to a first connector first end.
413 refers to a first connector second end.
414 refers to a first connector longitudinal section.
420 refers to a second connector.
430 refers to a connector first section.
431 refers to a connector first section first end.
432 refers to a connector first section second end.
433 refers to a connector first section longitudinal section.
440 refers to a connector second section.
441 refers to a connector second section first end.
442 refers to a connector second section second end.
443 refers to a connector second section longitudinal section.
450 refers to a riser section.
500 refers to reinforcing members.
600 refers to a bracket.

The Figures show one embodiment of a vehicle hitch mounted cargo basket (10). The vehicle hitch mounted cargo basket may comprise a floor (100), one or more lip members (200), a rim (300), a connector (400), one or more reinforcing members (500), and a at least bracket (600) as shown in the Figures.

The floor (100) may have any number of shapes including triangular, quadrilateral, ovular, circular, hexagonal, and the like. One preferred embodiment of the floor has a substantially rectangular shape as shown in the figures. In such embodiments, the floor will have a floor first side (110), a floor second side (120) opposite the floor first side, a floor first end (130) extending between the floor first side and the floor second side, and a floor second end (140) opposite the floor first end.

The floor will also have top surface (150) and a bottom surface (160). Passing through the floor from the top surface through the bottom surface may be one or more holes (170). The hole(s)—when present—may come in a variety of shapes and sizes. The holes allow for drainage of fluids—such as rainwater—from the cargo basket and may also serve as a mounting point to attach straps, carabiners, hooks, bolts, screws, tie-downs, bungee cords, and the like and other attachment mechanisms which assist in holding cargo in place inside the vehicle hitch mounted cargo basket. A fabric cover or tarp may also be securely fastened to the floor using such attachment mechanisms to cover and protect a load being carried in the vehicle hitch mounted cargo basket.

One or more lip members (200) extends upwardly from the top surface (150). In the embodiment shown in the figures there is a first lip member (210) extending upwardly from the top surface along at least a portion of the floor first side (110), a second lip member (220) extending upwardly from the top surface along at least a portion of the floor second side (120), a third lip member (230) extending upwardly from the top surface along at least a portion of the floor first end (130), and a fourth lip member (240) extending upwardly from the top surface along at least a portion of the floor second end (240). Each lip member may include one or more slots (250) which may serve as a mounting point to attach straps and other attachment mechanisms which assist in holding cargo in place inside the vehicle hitch mounted cargo basket.

Attached to a top edge of each of the lip members (200) may be a rim (300). The rim will typically have a substantially cylindrical cross sectional profile as shown in the Figures. Typically the rim will have a shape and size which substantially conforms to the exterior profile of the floor (100). That is to say that, when the floor has a substantially rectangular shape, the rim will have a substantially rectangular shape of similar dimensions to the rectangular shape of the floor.

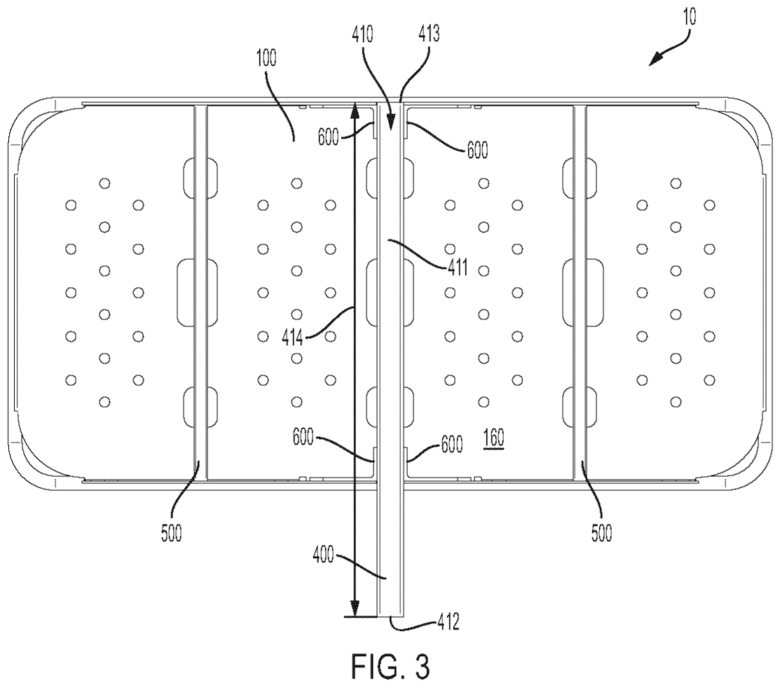

Attached to the bottom surface (160) of the floor (100) may be the connector (400) and one or more reinforcing members (500). Preferably the connector will be attached to the bottom surface at or near a midpoint between the floor first end (130) and the floor second end (140). The connector then extends past the floor second edge (120) and is configured to mate with a standard vehicle hitch receiver. One or more of the brackets (600) may be attached between the connector and one or both of the floor and/or at least one of the lip members—preferably the first lip member (210) and/or the second lip member (220). One example of such a bracket is an L bracket as shown in FIG. 3.

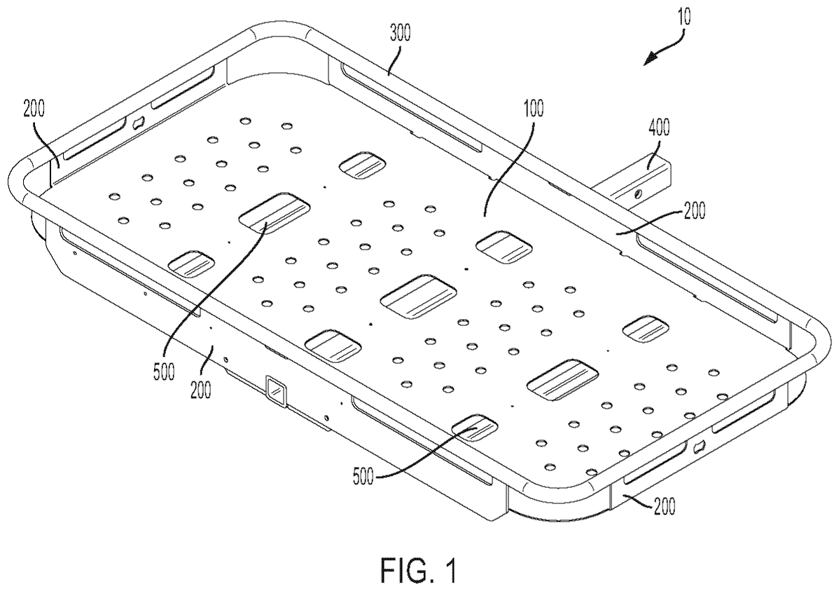

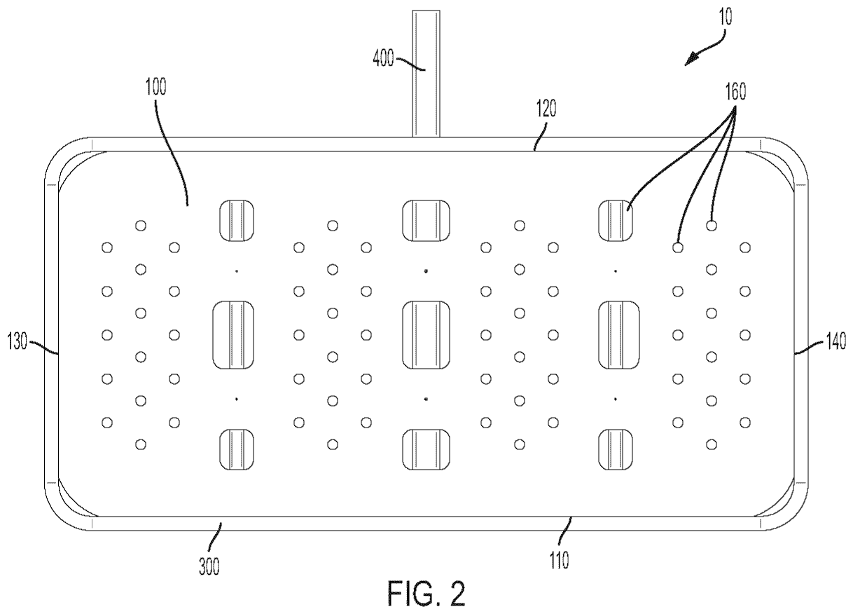

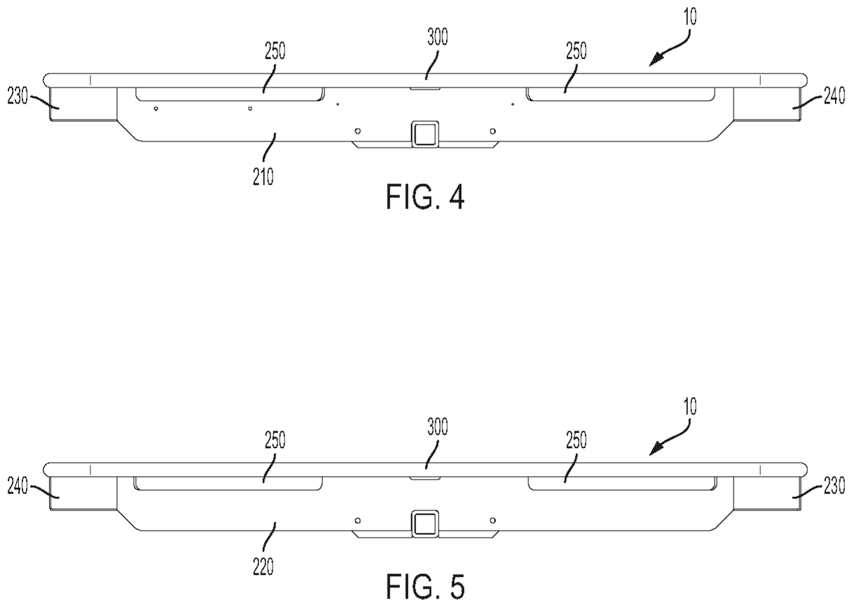

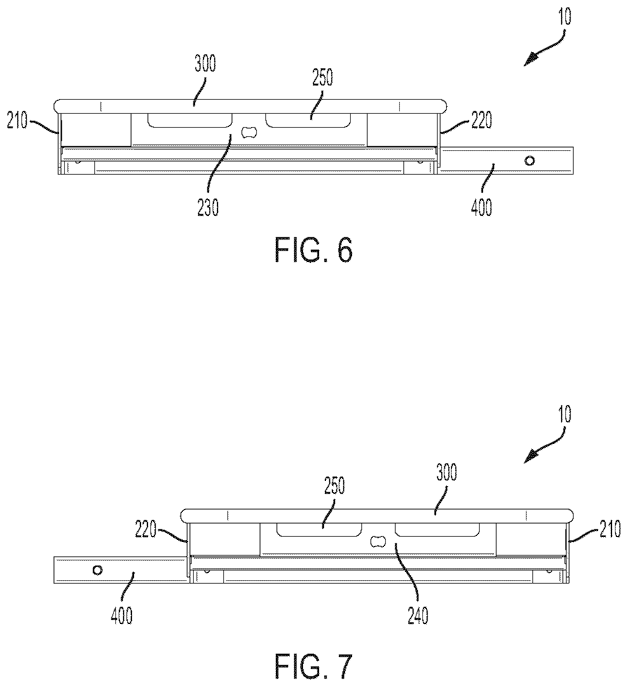

The connector (400) may come in several forms. As shown in FIGS. 1 to 7, the connector may be a straight connector—also referred to herein as a first connector (410). The first connector—when present—includes a first connector member (411) having a first connector first end (412) and a first connector second end (413) opposite the first connector first end. A first connector longitudinal section (414) extends between the first connector first end and the first connector second end with the first connector second end extending past the floor second edge (120) and configured to mate with a standard vehicle hitch receiver.

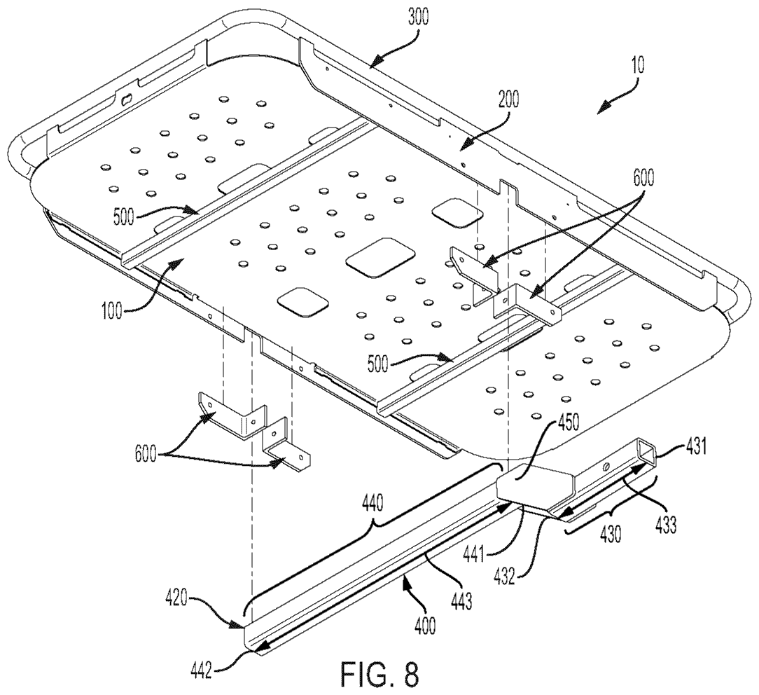

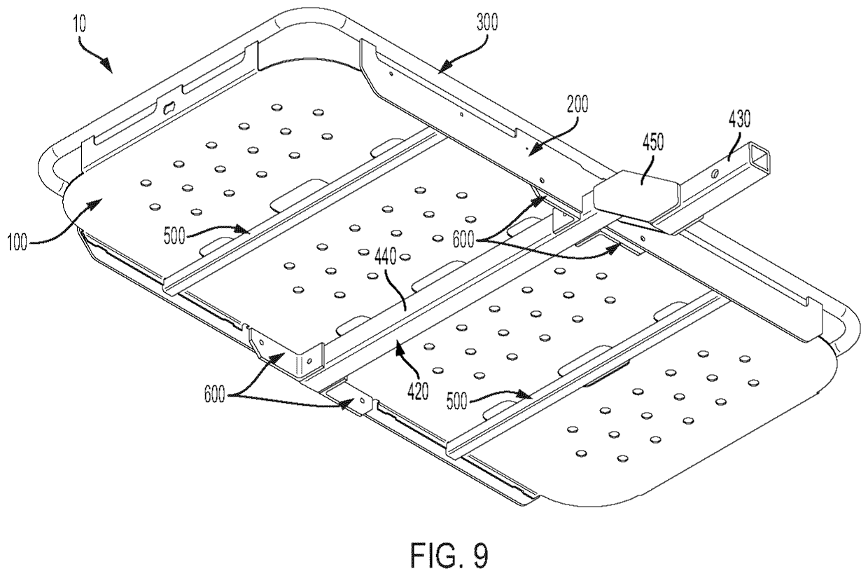

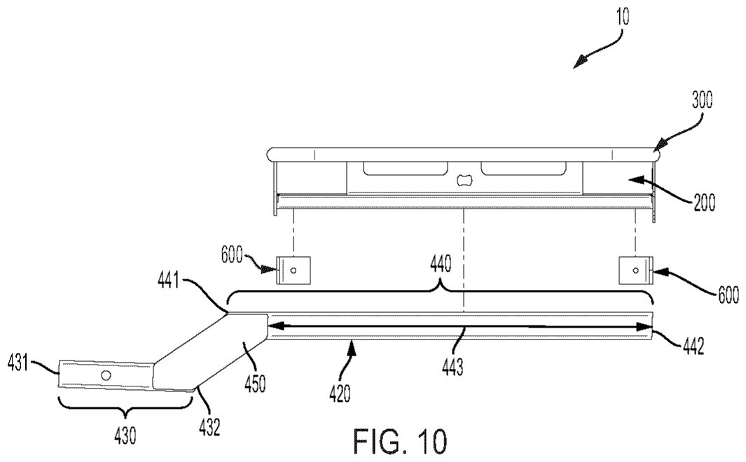

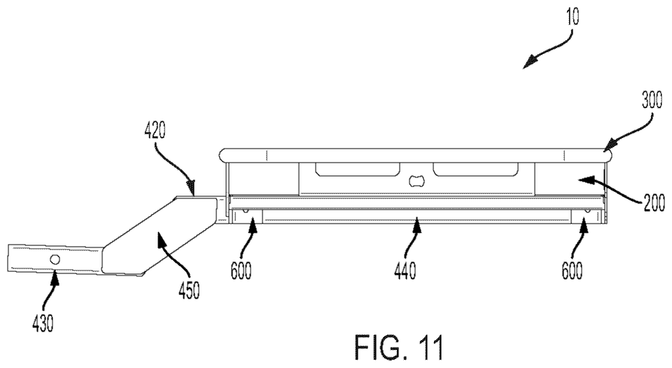

In other embodiments, as shown in FIGS. 8 to 11, the connector may include be an offset connector—also referred to herein as a second connector (420). The second connector—when present—includes a connector first section (430), a connector second section (440), and a riser section (450). The connector first section having a connector first section first end (431) and a connector first section second end (432) opposite the connector first section first end. A connector first section longitudinal section (433) extends between the connector first section first end and the connector first section second end. Similarly, the connector second section has a connector second section first end (441) and a connector second section second end (442) opposite the connector second section second end. A connector second section longitudinal section (443) extends between the connector second section first end and the connector second section second end.

In the second connector (420), the riser section (450) may be connected to and extend substantially vertically between the connector first section second end (432) and the connector second section first end (441) to allow for a vertical distance between the connector first section (430) and the connector second section (440). In some embodiments, the vertical distance between the connector first section and the connector second section may be in a range of between 3 inches and 5 inches. In other embodiments, the vertical distance between the connector first section and the connector second section may be in a range of between 5 inches and 9 inches.

While the connector—including either a first connector (410) and/or a second connector (420)—may be permanently attached to the bottom surface (160) of the floor (100) such as by welding or by manufacturing the connector and the floor of a single integral piece of material, it is preferred that the connector be removably connected to the bottom surface by fasteners—such as bolts, screws, rivets, clamps, or the like—which fasten the L brackets (600) between the floor and the connector as illustrated in FIGS. 8 to 11.

In some embodiments, the vehicle hitch mounted cargo basket (10) may be provided in the form of a vehicle hitch mounted cargo basket kit. In kit form, the vehicle hitch mounted cargo basket may include any of the embodiments of a floor (100), lip member(s) (200), a rim (300), reinforcing member(s) (500), and L brackets (600) described herein along with a plurality of connectors (400). The plurality of connectors may include a first connector (410) of any type described herein and at least one second connector (420) of any type described herein. In some embodiments, the kit may include two second connectors—referred to herein as a first second connector and a second second connector. In such embodiments, the first second connector may have a riser section configured to allow a vertical distance between the connector first section and the connector second section in a range of between 3 and 5 inches while the second second connector may have a second riser section configured to allow a vertical distance between the connector first section and the connector second section in a range of between 5 inches and 9 inches.

The one or more reinforcing members (500) may be connected to the bottom surface (160) of the floor (100) in any number of locations. One embodiment shown in the figures includes two reinforcing members connected to the bottom surface and extending between the floor first side (110) and the floor second side (120).

The vehicle hitch mounted cargo basket may be made of any number of materials using any number of manufacturing techniques. The preferred material is aluminum as it is lightweight and durable. Other materials may include steel, thermoset materials, thermoplastic materials, fiber reinforced thermoplastic materials, and/or other lightweight, durable materials. The preferred manufacturing technique involves machining the various components of sheets or tubes of aluminum using waterjet, laser-cutting, or similar machines and welding the components together in the desired configuration. Other manufacturing techniques may include casting, 3D printing, machining from a piece of billet material, stamping, molding, extruding, pultruding, heat treating, bending, injection molding, and others.

The foregoing description of the exemplary embodiments has been provided for the purpose of illustration and description. It is not intended to be exhaustive or to limit the invention to the precise forms disclosed. Many modifications and variations will be apparent to practitioners skilled in the art. The embodiments were chosen and described to best explain the principles of the invention and its practical applications. It is intended that the scope of the invention be defined by the following claims and their equivalents.

What is claimed is:

1. A vehicle hitch mounted cargo basket (10) kit, comprising:
a floor (100) having a floor first side (110), a floor second side (120) opposite the floor first side, a floor first end (130) extending between the floor first side and the floor second side, a floor second end (140) opposite the floor first end, a top surface (150), and a bottom surface (160);
at least one lip member (200) extending upwardly from the top surface;
a rim (300) attached to a top edge of each lip member;
a plurality of connectors (400) configured to interchangeably attach to the bottom surface at or near a midpoint between the floor first end and the floor second end;
at least one reinforcing member (500) attached to the bottom surface of the floor; and
a plurality of L brackets (600) configured to attach between at least one of the lip members and the connectors; and
wherein at least a portion of each connector of the plurality of connectors is configured to extend past the floor second edge.

2. The vehicle hitch mounted cargo basket kit of claim 1, wherein the plurality of connectors comprises at least:
a first connector (410) comprising a first connector member (411) having a first connector first end (412), a first connector second end (413) opposite the first connector first end, and a first connector longitudinal section (414) extending between the first connector first end and the first connector second end;
at least one second connector (420) comprising:
a connector first section (430) having a connector first section first end (431), a connector first section second end (432) opposite the connector first section first end, and a connector first section longitudinal section (433) extending between the connector first section first end and the connector first section second end;
a connector second section (440) having a connector second section first end (441), a connector second section second end (442) opposite the connector second section first end, and a connector second section longitudinal section (443) extending between the connector second section first end and the connector second section second end; and
a riser section (450) connected to and extending substantially vertically between the connector first section second end and the connector second section first end.

3. The vehicle hitch mounted cargo basket kit of claim 2, wherein the at least one second connector comprises:
a first second connector having a first riser section configured to allow a vertical distance between the connector first section and the connector second section in a range of between 3 inches and 5 inches; and
a second second connector having a second riser section configured to allow a vertical distance between the connector first section and the connector second section in a range of between 5 inches and 9 inches.

4. The vehicle hitch mounted cargo basket kit of claim 2, further comprising one or more holes (170) passing through the floor from the top surface through the bottom surface.

5. The vehicle hitch mounted cargo basket kit of claim 2, wherein the at least one lip member comprises:
a first lip member (210) extending upwardly from the top surface along at least a portion of the floor first side;
a second lip member (220) extending upwardly from the top surface along at least a portion of the floor second side;
a third lip member (230) extending upwardly from the top surface along at least a portion of the floor third side; and
a fourth lip member (240) extending upwardly from the top surface along at least a portion of the floor fourth side.

6. The vehicle hitch mounted cargo basket kit of claim 2, wherein the at least one lip member comprises at least one slot.

7. The vehicle hitch mounted cargo basket kit of claim 2, wherein the rim has a substantially cylindrical cross sectional profile.

8. The vehicle hitch mounted cargo basket kit of claim 2, wherein the rim has a shape and size which substantially conforms to the exterior profile of the floor.

9. The vehicle hitch mounted cargo basket kit of claim 2, wherein the at least one reinforcing member comprises two reinforcing members connected to the bottom surface and extending between the floor first side and the floor second side.

10. The vehicle hitch mounted cargo basket kit of claim 2, wherein the vehicle hitch mounted cargo basket is comprised of a material which comprises aluminum.

11. A vehicle hitch mounted cargo basket (10), comprising:
a floor (100) having a floor first side (110), a floor second side (120) opposite the floor first side, a floor first end (130) extending between the floor first side and the floor second side, a floor second end (140) opposite the floor first end, a top surface (150), and a bottom surface (160);
at least one lip member (200) extending upwardly from the top surface;
a rim (300) attached to a top edge of each lip member;
a connector (400) removably connected to the bottom surface at or near a midpoint between the floor first end and the floor second end, said connector comprising:
a connector first section (430) having a connector first section first end (431), a connector first section second end (432) opposite the connector first section first end, and a connector first section longitudinal section (433) extending between the connector first section first end and the connector first section second end;
a connector second section (440) having a connector second section first end (441), a connector second section second end (442) opposite the connector second section first end, and a connector second section longitudinal section (443) extending between the connector second section first end and the connector second section second end; and
a riser section (450) connected to and extending substantially vertically between the connector first section second end and the connector second section first end;
at least one reinforcing member (500) attached to the bottom surface of the floor; and
a plurality of L brackets (600) configured to removably connect between at least one of the lip members and the connector; and
wherein at least a portion of the connector extends past the floor second edge and is configured to mate with a vehicle hitch receiver.

12. The vehicle hitch mounted cargo basket of claim 11, wherein the riser section is configured to allow a vertical distance between the connector first section and the connector second section in a range of between 3 inches and 5 inches.

13. The vehicle hitch mounted cargo basket of claim 11, wherein the riser section is configured to allow a vertical distance between the connector first section and the connector second section in a range of between 5 inches and 9 inches.

14. The vehicle hitch mounted cargo basket of claim 11, further comprising one or more holes (170) passing through the floor from the top surface through the bottom surface.

15. The vehicle hitch mounted cargo basket of claim 11, wherein the at least one lip member comprises:
a first lip member (210) extending upwardly from the top surface along at least a portion of the floor first side;
a second lip member (220) extending upwardly from the top surface along at least a portion of the floor second side;
a third lip member (230) extending upwardly from the top surface along at least a portion of the floor third side; and
a fourth lip member (240) extending upwardly from the top surface along at least a portion of the floor fourth side.

16. The vehicle hitch mounted cargo basket of claim 11, wherein the at least one lip member comprises at least one slot.

17. The vehicle hitch mounted cargo basket of claim 11, wherein the rim has a substantially cylindrical cross sectional profile.

18. The vehicle hitch mounted cargo basket of claim 11, wherein the rim has a shape and size which substantially conforms to the exterior profile of the floor.

19. The vehicle hitch mounted cargo basket of claim 11, wherein the at least one reinforcing member comprises two reinforcing members connected to the bottom surface and extending between the floor first side and the floor second side.

20. The vehicle hitch mounted cargo basket of claim 11, wherein the vehicle hitch mounted cargo basket is comprised of a material which comprises aluminum.
